(19) United States
(12) Patent Application Publication
(10) Pub. No.: US 2018/0073549 A1
(43) Pub. Date: Mar. 15, 2018

(54) Wall Hook

(71) Applicant: Melanie Cogburn, Austin, TX (US)

(72) Inventor: Melanie Cogburn, Austin, TX (US)

(21) Appl. No.: 15/701,080

(22) Filed: Sep. 11, 2017

Related U.S. Application Data
(60) Provisional application No. 62/394,098, filed on Sep. 13, 2016.

(51) Int. Cl. F16B 43/02; F16B 45/00; F16M 13/02; F16B 15/02

(52) U.S. Cl. CPC F16B 43/02; F16B 15/02; F16M 13/02; F16B 45/00

(57) ABSTRACT

A hook system of a unibody structure with three platforms that face an angled hole. The hook system includes nails adapted to be particularly suitable for mounting the hook and platform inserts to receive the nails.

### CROSS-REFERENCE TO RELATED APPLICATIONS

This application claims the benefit of U.S. provisional patent application Ser. No. 62/394,098, filed Sep. 11, 2017.

### TECHNICAL FIELD

This disclosure relates generally to wall mountings or objects suitable to be attached to a vertical surface, and more particularly to wall mountable hooks for household or other suitable uses, and systems for mounting same.

### BACKGROUND

The problem sought to be solved is to provide large wall hook that a person can mount on a surface such as a wall by hammering one or more nails into the surface through a mounting potion of the hook. One object of the invention is to avoid using a drill, such as to drill hole into the surface as a guide hole and then nail or screw in a hook with drywall anchors.

No-drill hooks are currently limited to hooks that attach to wall with adhesives of different types, including Command™ hooks by 3M which have a special pull down tape. However, these hooks are extremely limited in how much weight they can carry. Current limits of Command™ hooks are 7 lbs.

Originally, regular nails, uniform in diameter throughout body of nail, were used but they created too much give/movement, which made the hook vertically unstable when repeatedly adding and removing large weight (like a backpack with books).

OOK hook wall hangers are small picture hangers that are installed with nails and that carry weight—specifically weight that does not shift such as a picture or mirror that hangs statically on the wall surface. Such hangers also utilize nails positioned at an angle. However, the present invention is different with respect to the angle/balance feature, the size and purpose of the hook, the needle nail or variable girth feature in which the nails have a variable girth that exceeds or equals the width of the nail guide hole, and in some embodiments, how nails are removed.

### SUMMARY

A hook of the present invention comprises of a unibody structure with three platforms that face an angled hole. A hook system of the present invention includes nails adapted to be particularly suitable for mounting the hook and platform inserts to receive the nails.

### BRIEF DESCRIPTION OF THE DRAWINGS

For a more complete understanding of the present disclosure, and the advantages thereof, reference is now made to the following descriptions taken in conjunction with the accompanying drawings, in which:

FIG. 1 is a horizontal side view diagrammatic illustration of an exemplary embodiment of a hook of the present disclosure.

FIG. 2 is a side view diagrammatic illustration of a detail of an alternative embodiment of the hook of FIG. 1.

FIG. 3 is a perspective vertical view diagrammatic illustration of an exemplary embodiment of a hook of the present disclosure.

FIG. 4 is a vertical front view diagrammatic illustration of an exemplary embodiment of the hook of FIG. 3.

FIG. 5 is a vertical side view diagrammatic illustration of an exemplary embodiment of the hook of FIG. 3.

FIG. 6 is a perspective view diagrammatic illustration of an exemplary embodiment of a needle-type nail for a hook system of the present invention.

FIG. 7 is a perspective side view of an alternative exemplary embodiment of a nail for a hook system of the present invention.

FIG. 8 is a perspective view diagrammatic illustration of an exemplary embodiment of a nail sleeve for a hook system of the present invention.

FIG. 9 is a perspective vertical view diagrammatic illustration of an alternative embodiment of a hook system of the present disclosure.

FIG. 10 is a perspective horizontal view diagrammatic illustration of an alternative embodiment of a nail for a hook system of the present disclosure.

### DETAILED DESCRIPTION

The following discussion is directed to various embodiments of the invention. The term “invention” is not intended to refer to any particular embodiment or otherwise limit the scope of the disclosure. Although one or more of these embodiments may be preferred, the embodiments disclosed should not be interpreted, or otherwise used, as limiting the scope of the disclosure, including the claims. In addition, one skilled in the art will understand that the following description has broad application, and the discussion of any embodiment is meant only to be exemplary of that embodiment, and not intended to intimate that the scope of the disclosure, including the claims, is limited to that embodiment.

In the following discussion and in the claims, the terms “including” and “comprising” are used in an open-ended fashion, and thus should be interpreted to mean “including, but not limited to.” Also, the term “connect” or “connected” where used if at all is intended to mean either an indirect or direct connection. Thus, if a first component connects to a second component, that connection may be through a direct connection or through an indirect connection via other components and connections.

Certain terms are used throughout the following description and claims to refer to particular system components and method steps. As one skilled in the art will appreciate, different companies may refer to a component by different names. This document does not intend to distinguish between components that differ in name but not function.

The problem sought to be solved is to provide a large wall hook that a person can mount on a surface such as a wall by hammering one or more nails into the surface through a mounting potion of the hook. One object of the invention is to avoid using a drill, such as to drill hole into the surface as a guide hole and then nail or screw in a hook with drywall anchors.

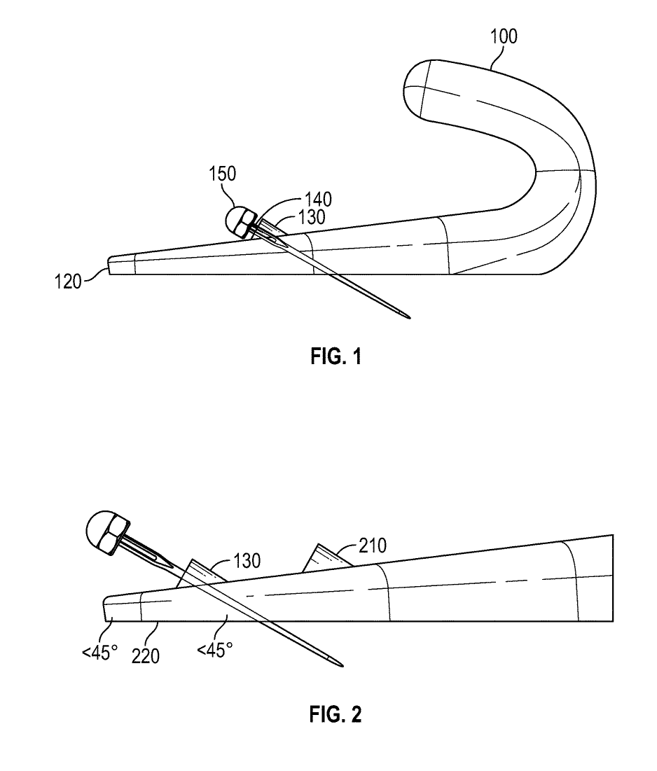

Turning now to the drawings, FIG. 1 is a horizontal side view diagrammatic illustration of an exemplary embodiment of a hook of the present disclosure. Hook 100 includes top portion 120 and platform 130 below top portion 120. Nail 140 is disposed through platform 130. Nail head 150 is formed with facets or other suitable topographical features to facilitate removal of nail 140 with pliers or even by hand.

FIG. 2 is a side view diagrammatic illustration of a detail of an alternative embodiment of the hook of FIG. 1. The embodiment of FIG. 2 provides a plurality of platforms 130, 210 through which to drive a nail 140. The body 220 of hook 100 is tampered or angled at a preferred angle of 45°.

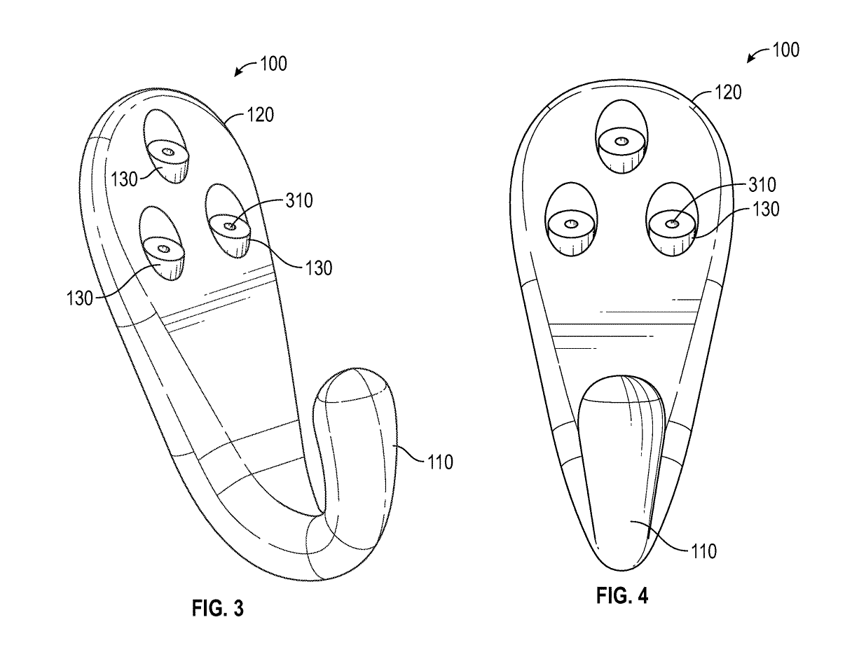

FIG. 3 is a perspective vertical view diagrammatic illustration of an exemplary embodiment of a hook of the present disclosure. Platforms 130 provide guide holes 310 for nails 140. Note the bulk of hook 100. It is intended for robust use and be easy to install and remove with minimal tools.

FIG. 4 is a vertical front view diagrammatic illustration of an exemplary embodiment of the hook of FIG. 3. Hook body 220 is scalloped in portions to accommodate angled platforms 130. The angled platforms 130 provide angled guide holes 310 so that nails 140 penetrate the hanging substrate, such as a wall, at an angle to provide a secure purchase for the hook against the substrate.

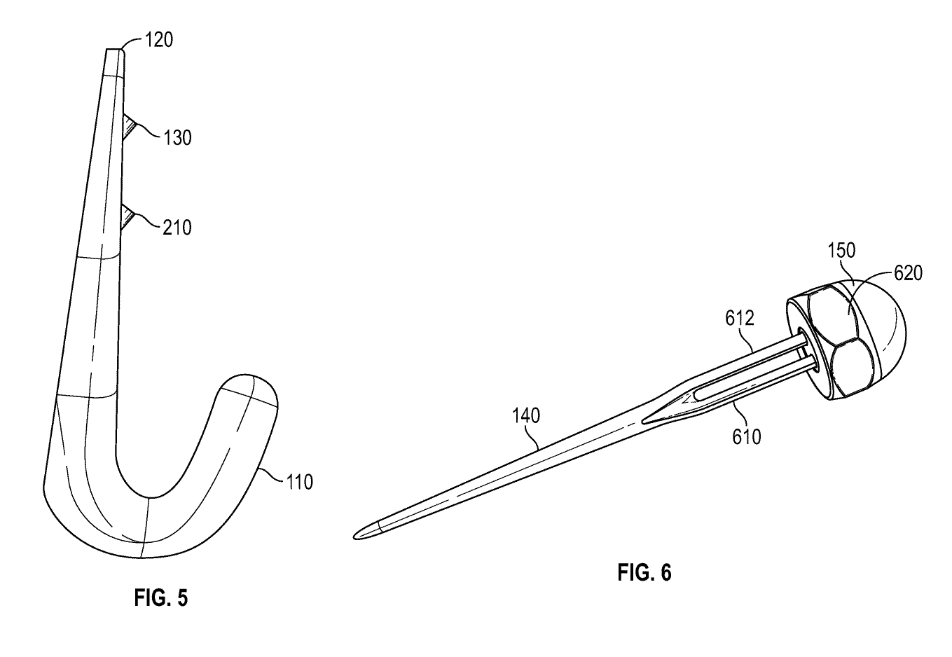

FIG. 5 is a vertical side view diagrammatic illustration of an exemplary embodiment of the hook of FIG. 3. The angled positioning of platforms 130, 210 is readily discernable. Thin top portion 120 widens descending to be thicker at bottom portion 110.

FIG. 6 is a perspective view diagrammatic illustration of an exemplary embodiment of a needle-type nail for a hook system of the present invention. Preferably a nail 140 of a hook system of the present invention is tapered so as to be thicker or wider at the top than at the bottom alonf the length of the nail body. One way to achieve tapering is with a needle-type nail that has prongs 610, 612 at the head 150 end of nail 140. An advantage of a pronged nail is that the prongs are biased so as to provide a tight fit when disposed in a platform 130. Nail head 150 is formed with facets 620 or other suitable topographical features to facilitate removal of nail 140 with pliers or even by hand.

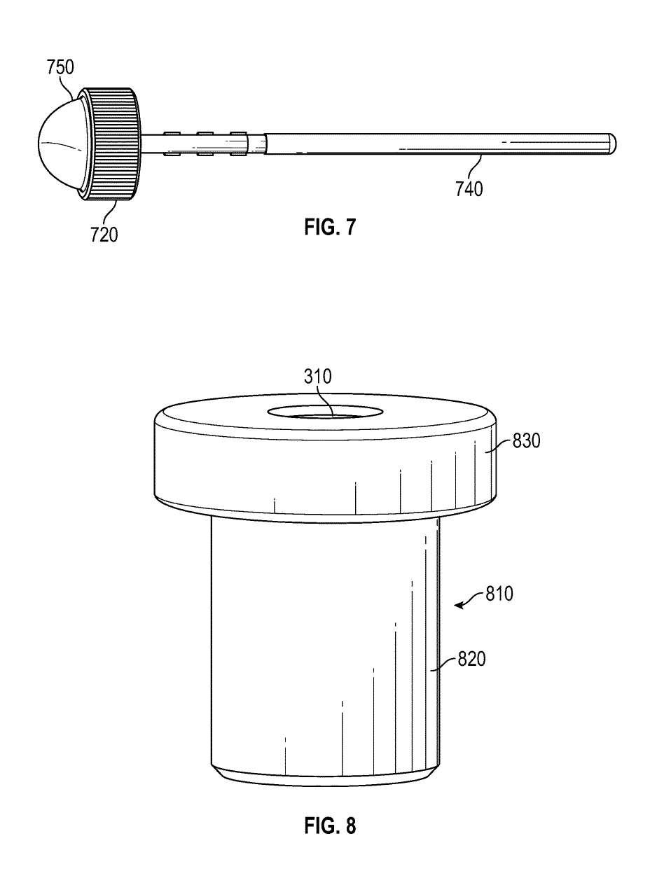

FIG. 7 is a perspective side view of an alternative exemplary embodiment of a nail for a hook system of the present invention. Nail 740 has nail head 750 with ribbing around the head to facilitate removal of nail 740. Platform gripping topographical features are present at the top end of nail 740 below head 750.

FIG. 8 is a perspective view diagrammatic illustration of an exemplary embodiment of a nail sleeve for a hook system of the present invention. Sleeve 810 has body portion 820 that sits in a platform 130, and collar portion 830 that retains sleeve 810 in a platform 130. Nail access to platform guide hole 310 is provide with a bore through sleeve 810.

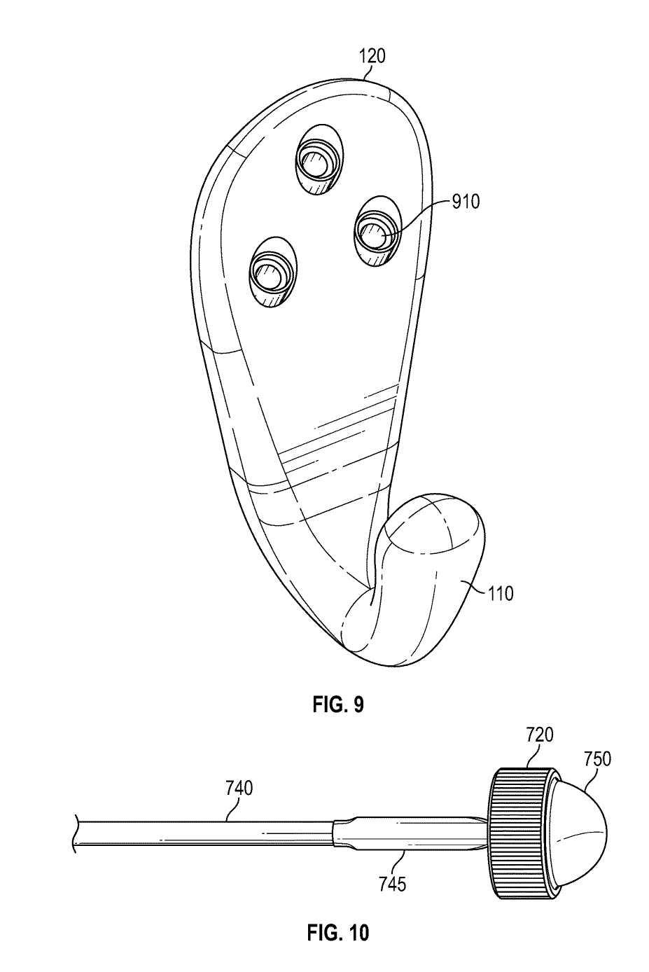

FIG. 9 is a perspective vertical view diagrammatic illustration of an alternative embodiment of a hook system of the present disclosure. Platform 910 is formed with features to hold sleeve 810.

FIG. 10 is a perspective horizontal view diagrammatic illustration of an alternative embodiment of a nail for a hook system of the present disclosure. Flared wide top portion 745 provides a tight fit in guide hole 310. Nail head 750 provides ribbed portion 720 to facilitate easy removal of nail 740 from guide hole 310.

No-drill hooks are currently limited to hooks that attach to wall with adhesives of different types, including Command™ hooks by 3M which have a special pull down tape. However, these hooks are extremely limited in how much weight they can carry. Current limits of Command™ hooks are 7 lbs.

The hook design of the present invention can carry weight of at least 20 lbs and possibly as much as 50 lbs.

Hook comprises of a unibody structure with three platforms that face an angled hole. In an exemplary embodiment of the hook, the hole angle is 35 degrees.

The invention further contemplates a hook mounting system that includes pin nails designed from needles and acorn screw caps adapted to be particularly suitable for being driven through the angled holes with a hammer.

The needle design creates a “grab” into the hook so the pin nail is stabilized within the hook. This reduces lateral and vertical movement when the hook is installed on the wall. A needle-type nail is a specific exemplary embodiment. Other types of nails or mounting means may be suitable, provided that the upper shaft of the nail is tapered to be slightly wider at the top so as to approach or exceed the full diameter of nail hole to obtain a snug friction fit between the nail and the hole. A preferred embodiment of a hook system of the present invention provides such a tapered nail. FIGS. 6, 7 and 10 illustrate exemplary embodiments of such tapered nails. Nevertheless, the present invention contemplates non-tapered nails having a uniform girth along the length.

The hook features one or more angled nail holes, combined with an increase in the thickness of the mounting portion of the hook such that the material of the hook is thickest at the hook end and thinnest at the top of the mounting portion of the hook. That is, a top nail hole, for example, is through a thinner, mounting, portion of the hook and the bottom nail holes, for example, are through a thicker place in the mounting portion, closer to the hook portion of the hook.

In a preferred embodiment, a top nail is centered for ease of installation such that the top nail is installed first to position the hook on a surface, and then one or more secondary nails are installed below the top nail.

The nail can be removed by inserting a small flathead screwdriver at the base of nail head and using a small hammer to knock the nail upwards and out of the hook. This has benefits where the embodiment is attached high up on a wall, such as a bracket that holds a drapery rod. Other embodiments feature nail heads with threaded sides that can be removed with pliers, as illustrated in FIG. 6.

The platform and nail head are arranged and shaped so that when one hammer in the nail hook the hammer does not strike the hook itself.

Other applications include any brackets that are mounted to wall—the under bracket for towel rods, or drapery pole brackets, or picture hangers, or wall hooks of any size.

In a preferred embodiment the material of the hook is transparent. This allows it to be installed over wallpaper or high design environment, and allows the paint/wall covering to show through, making appearance of large hook less distinguishable or obvious from view.

OOK hook wall hangers are small picture hangers that are installed with nails and that carry weight. Such hangers also have an angled pin hook. However, the present invention is different with respect to the angle/balance feature, the size and purpose of the hook, the needle nail or variable girth feature, and in some embodiments how the nails are removed.

Many modifications and other embodiments of the wall hook and system described herein will come to mind to one skilled in the art to which this disclosure pertains having the benefit of the teachings presented in the foregoing descriptions and the associated drawings. Therefore, it is to be understood that the disclosure is not to be limited to the specific embodiments disclosed and that modifications and other embodiments are intended to be included within the scope of the appended claims. Although specific terms are employed herein, they are used in a generic and descriptive sense only and not for purposes of limitation.

I claim:

1. A wall hook system, the system comprising:
A hook having a top portion and a bottom portion thicker than the top portion, one or more angled platforms between the top portion and the bottom portion, each one of the one or more angled platforms having an angled guide hole; and
one or more nails, each of the one or more nails having a feature to provide a tight fit in the angled guide holes, and a nail head having a topographical feature to facilitate easy removal of the nail from the angled guide hole.

2. The wall hook system of claim 1, wherein at least one of the one or more angled platforms is formed to accommodate a sleeve, further comprising a sleeve disposable within the angled platform of the at least one of the one or more angled platforms.

3. The wall hook system of claim 2, wherein the sleeve comprises a bore to receive a nail.

4. The wall hook system of claim 2, wherein the sleeve further comprises a collar to provide a secure seat in the angled platform of the at least one of the one or more angled platforms.

5. The wall hook system of claim 1, wherein the nail feature to provide a tight fit in the angled guide holes comprises a flared wide top portion.

6. The wall hook system of claim 1, wherein the nail feature to provide a tight fit in the angled guide holes comprises prongs.

7. The wall hook system of claim 1, where the nail head topographical feature to facilitate removal comprises facets.

8. The wall hook system of claim 1, where the nail head topographical feature to facilitate removal comprises ribs.

9. A hook for a wall hook system, the hook comprising:
a top portion and a bottom portion thicker than the top portion; and
one or more angled platforms integral with the hook and disposed between the top portion and the bottom portion, each one of the one or more angled platforms having an angled guide hole.

10. The hook of claim 9, further comprising scalloped recesses for the one or more angled platforms.

11. The hook of claim 9, wherein the change in thickness from the top portion to the bottom portion defines an angle of 45°.

12. A nail for a wall hook system, the nail comprising a body portion and a head portion disposed on top of the body portion; the body portion further comprising an upper flared wide portion; and the head portion further comprising facets.
